(19) United States
(12) Patent Application Publication
(10) Pub. No.: US 2009/0183079 A1
(43) Pub. Date: Jul. 16, 2009

(54) Information Product and Method for Interacting with User

(75) Inventors: Ai-Min Li, Shanghai City (CN); Zheng Zhang, Shanghai City (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INVENTEC APPLIANCES CORP., Taipei Hsien (TW)

(21) Appl. No.: 12/351,259

(22) Filed: Jan. 9, 2009

(30) Foreign Application Priority Data
Jan. 11, 2008 (TW) 97101245

(51) Int. Cl. G06F 3/02; G06F 3/01

(52) U.S. Cl. 715/727; 715/764

(57) ABSTRACT

An information product and a method for interacting with a user are disclosed. The information product comprises: an input module, a storage module, a detecting module, and a comparing module. In the method for interacting with the user, the user firstly affects the input module. Then, a predetermined input value is provided, wherein the predetermined input value corresponds to a predetermined message. Thereafter, a user input value corresponding to the user's affecting the input module is produced. Then, if the user input value substantially matches the predetermined input value is determined. When the user input value substantially matches the predetermined input value, the use of the predetermined message is controlled.

### RELATED APPLICATIONS

This application claims priority to Taiwan Application Serial Number 97101245, filed Jan. 11, 2008, which is herein incorporated by reference.

### FIELD OF THE INVENTION

This invention relates to an information product and a method for interacting with a user, and more particularly, to an information product and a method have emotion regulation function.

### BACKGROUND OF THE INVENTION

Because of the big life pressure and the sense of alienation, modern people sometimes have serious emotional fluctuations. Serious diseases, such as myocardial infraction, cerebral apoplexy, and brain attack, can be easily induced, when people are in a state of serious emotional fluctuations during a long time. However, as communication technologies develop, mobile communication devices, such as mobile phones and personal digital assistants (PDAs), are generally used in human life. Therefore, if these information products can be used to monitor users' emotion, the chances of getting the diseases induced by emotional fluctuations can be deceased.

Therefore, an information product and a method for interacting with users are required to regular the emotion of the users.

### SUMMARY OF THE INVENTION

An aspect of the present invention is to provide an information product for interacting with a user.

Another aspect of the present invention is to provide a method for interacting with a user.

According to an embodiment of the present invention, the information product comprises: an input module, a storage module, a detecting module, and a comparing module. The input module is for being affected by the user to control the information product. The storage module is for storing a predetermined input value, wherein the predetermined input value corresponds to a predetermined message. The detecting module is for producing a user input value corresponding to the user's affecting the input module. The comparing module is for determining if the user input value substantially matches the predetermined input value. When the user input value substantially matches the predetermined input value, the comparing module controls the use of the predetermined message.

According to another embodiment of the present invention, the information product comprises: a striking module, a sound receiving module, a sound detecting module, a pressure detecting module, a frequency detecting module, a storage module, a sound comparing module, a pressure comparing module, a frequency comparing module, a weight processing module, and an interaction processing module. The striking module is for being struck by the user to control the information product. The sound receiving module is for receiving sound of the user. The sound detecting module is for detecting the user sound and producing a user volume value corresponding to the user sound. The pressure detecting module is for detecting a pressure applied to the striking module by the user's striking, and producing a user striking pressure value corresponding to the pressure. The frequency detecting module is for detecting a striking frequency of the user's striking, and producing a user striking frequency value corresponding to the striking frequency. The storage module is used for storing a predetermined volume value, a predetermined pressure value, and a predetermined frequency value. The sound comparing module is for determining if the user volume value substantially matches the predetermined volume value, and thereby producing a first comparison result. The pressure comparing module is for determining if the user striking pressure value substantially matches the predetermined pressure value, and thereby producing a second comparison result. The frequency comparing module is for determining if the user striking frequency value substantially matches the predetermined frequency value, and thereby producing a third comparison result. A weight processing module is for multiplying the first comparison result by a first weight to obtain a first interaction parameter, multiplying the second comparison result by a second weight to obtain a second interaction parameter, and multiplying the third comparison result by a third weight to obtain a third interaction parameter. The interaction processing module is for summing up the first interaction parameter, the second interaction parameter, and the third interaction parameter to obtain a total interaction parameter, and determining if the total interaction parameter is substantially higher than a predetermined threshold. When the total interaction parameter is substantially higher than the predetermined threshold, the interaction processing module controls the use of a predetermined message.

According to still another embodiment of the present invention, in the method for interacting with a user, the user firstly affects an input module. Then, a predetermined input value is provided, wherein the predetermined input value corresponds to a predetermined message. Thereafter, a user input value corresponding to the user's affecting the input module is produced. Then, it is determined if the user input value substantially matches the predetermined input value. When the user input value substantially matches the predetermined input value, the use of the predetermined message is controlled.

According to still another embodiment of the present invention, the method for interacting with a user comprises the following steps. The user strikes a striking module. A sound receiving module then receives sound of the user. The user sound is then detected and a user volume value corresponding to the user sound is produced. Then a pressure applied to the striking module by the user's striking is detected, and a user striking pressure value corresponding to the pressure is produced. Then a striking frequency of the user's striking is detected, and a user striking frequency value corresponding to the striking frequency is produced. Also, a predetermined volume value, a predetermined pressure value, and a predetermined frequency value are provided. Then it's determined if the user volume value substantially matches the predetermined volume value, and thereby a first comparison result is produced. Then it's determined if the user striking pressure value substantially matches the predetermined pressure value, and thereby a second comparison result is produced. Then it's determined if the user striking frequency value substantially matches the predetermined frequency value, and thereby a third comparison result is produced. Then the first comparison result is multiplied by a first weight to obtain a first interaction parameter, the second comparison result is multiplied by a second weight to obtain a second interaction parameter, and the third comparison result is multiplied by a third weight to obtain a third interaction parameter. Afterwards, the first interaction parameter, the second interaction parameter, and the third interaction parameter are summed up to obtain a total interaction parameter, and it's determined if the total interaction parameter is substantially higher than a predetermined threshold. Finally, when the total interaction parameter is substantially higher than the predetermined threshold, the use of a predetermined message is controlled.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a functional block diagram showing an information product 100 according to a first embodiment of the present invention;

FIG. 2 is a flow chart showing a method for interacting with the user according to the first embodiment of the present invention;

FIG. 3 is a functional block diagram showing an information product according to a second embodiment of the present invention;

FIG. 4 is a functional block diagram showing an information product according to a third embodiment of the present invention;

FIG. 5 is a functional block diagram showing an information product according to a fourth embodiment of the present invention;

FIG. 6 is a functional block diagram showing an information product according to a fifth embodiment of the present invention;

FIG. 7 is a functional block diagram showing an information product for interacting a user according to a seventh embodiment of the present invention;

FIG. 8 to FIG. 10 is a flow chart showing a method for interacting the user according to the seventh embodiment of the present invention; and

FIG. 11 is a functional block diagram showing an information product 800 according to an eighth embodiment of the present invention.

### DETAILED DESCRIPTION OF THE PREFERRED EMBODIMENT

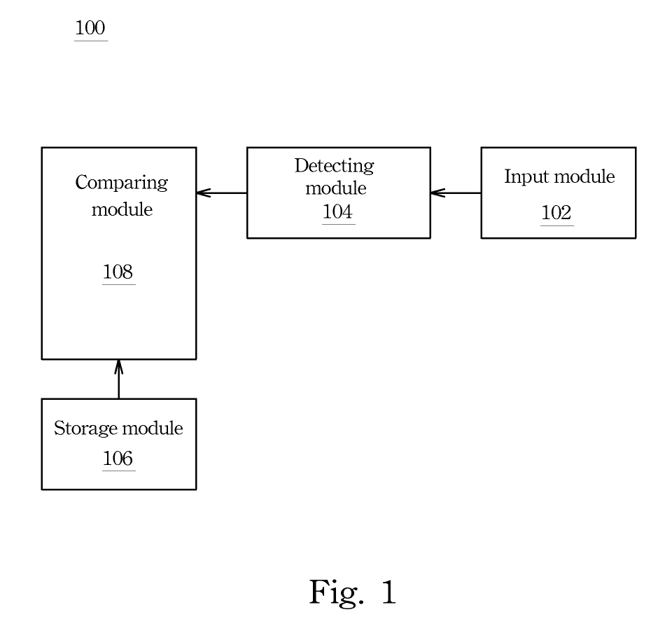

In order to make the illustration of the present invention more explicit and complete, the following description is stated with reference to FIG. 1 through FIG. 11.

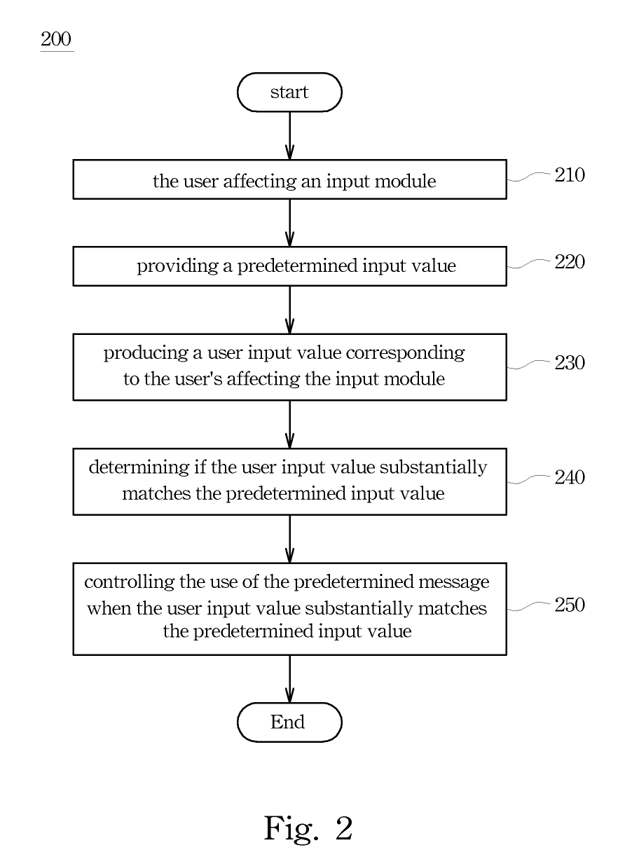

Refer to FIG. 1 and FIG. 2 simultaneously. FIG. 1 is a functional block diagram showing an information product 100 for interacting with a user according to a first embodiment of the present invention. FIG. 2 is a flow chart showing a method 200 for interacting with the user according to the first embodiment of the present invention. The information product 100 comprises an input module 102, a detecting module 104, a storage module 106, and a comparing module 108. The input module 102 is for being affected by a user to control the information product 100. The detecting module 104 is for producing a user input value corresponding to the user's affecting the input module. The storage module 106 stores a plurality of predetermined input values, wherein the predetermined input value corresponding to a predetermined message. The comparing module 108 is for determining if the user input value substantially matches one of the predetermined pressure values. When the user input value substantially matches the predetermined input value, the comparing module 108 controls the use of the predetermined message.

In the method 200, the input module 102 is firstly affected by the user in a step 210. Then, a predetermined input value is provided in a step 220, wherein the predetermined input value corresponds to a predetermined message. Thereafter, a user input value is produced corresponding to the user's affecting the input module 102 in a step 230. Then, the comparing module 108 determines if the user input value substantially matches the predetermined input value in a step 240. Thereafter, the use of the predetermined message is controlled when the user input value substantially matches the predetermined input value in a step 250. For specifying the first embodiment, various exemplary examples are presented in the following description.

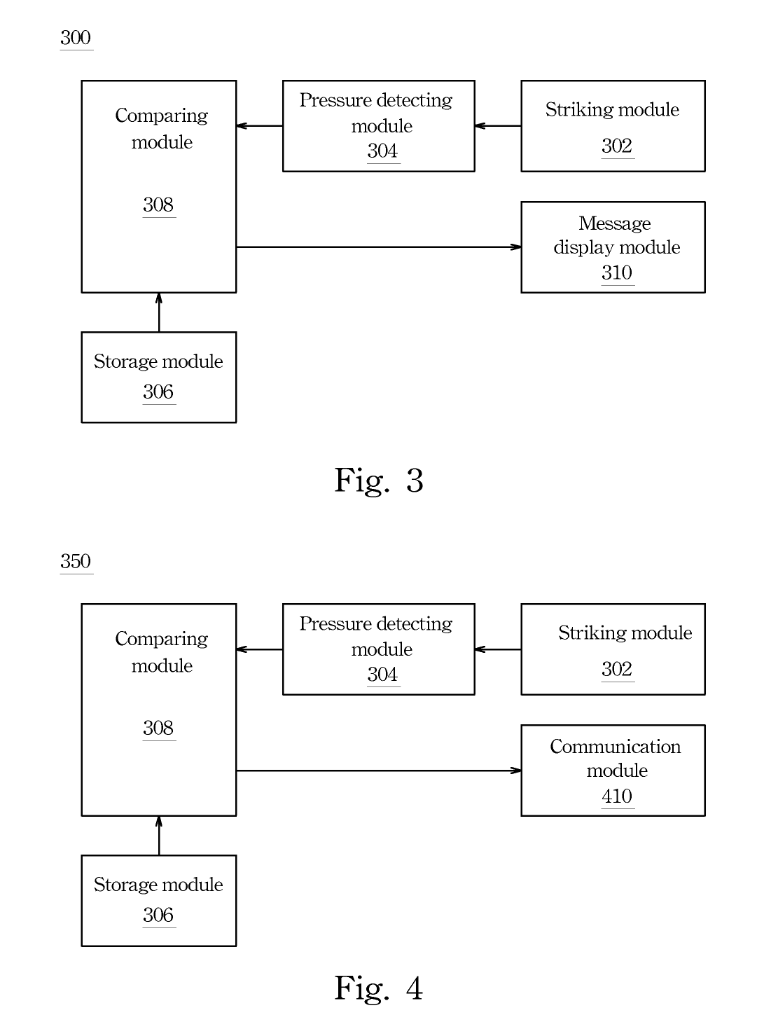

Refer to FIG. 3. FIG. 3 is a functional block diagram showing an information product 300 according to a second embodiment of the present invention. The information product 300 is an exemplary example for specifying the first embodiment. The information product 200 comprises a striking module 302, a pressure detecting module 304, a storage module 306, a comparing module 308, and a message display module 310. The striking module 302 is for being struck to control the information product 300. The pressure detecting module 304 is for detecting a pressure applied to the striking module by a user, thereby outputting a user striking pressure value. The storage module 306 stores a plurality of predetermined pressure values. The predetermined pressure values are collected samples when the user strikes the striking module 302 with various emotions. The comparing module 308 is for determining if the user striking pressure value substantially matches one of the predetermined pressure values, thereby outputting a comparing result. The message display module 310 is for displaying one of a plurality of predetermined messages, and the predetermined messages are corresponding to the predetermined pressure values in an one-to-one manner. When the comparing result is yes, the comparing module 308 directs the message display module 310 to display a predetermined message, wherein the predetermined message is corresponding to a predetermined pressure value, and the predetermined pressure value substantially matches the user striking pressure value.

In this example, the information product 300 can be a mobile phone, and the striking module 302 is a keyboard of the mobile phone. At first, the user collects the predetermined pressure values when he strikes the keyboard in the state of anger, happiness, tension, and so on, wherein the predetermined pressure values are samples corresponding to the user's various emotions in a one-to-one manner. Then, storage module 306 can be used to store the predetermined pressures values. Thereafter, each of the predetermined pressure values is set to be corresponding to a predetermined message. For example, the predetermined message corresponding to anger can be “All things come to him who waits”. Then, the pressure detecting module 304 is used to detect the pressure applied to the keyboard by the use, thereby outputting the user striking pressure value. Thereafter, the comparing module 308 is used to determine if the user striking pressure value is equal to one of the predetermine pressure values. When the user striking pressure value is equal to the predetermined value corresponding to anger, the comparing module 108 directs the message display module 310 to output the words “All things come to him who waits” to lower the emotional fluctuations of the user. In addition, the message display module may comprise a processor, a screen, and a horn, so the predetermined message can be set as words, images, or sounds.

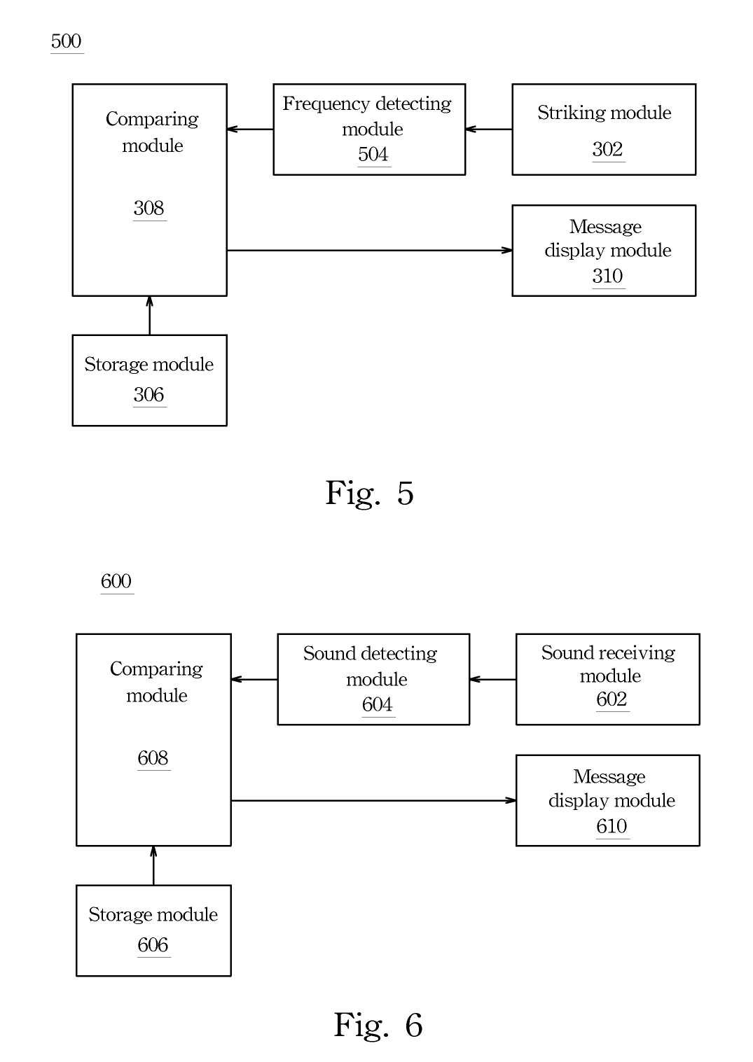

Refer to FIG. 4. FIG. 4 is a functional block diagram showing an information product 350 according to a third embodiment of the present invention. The information product 350 is similar to the information product 300, but the difference is that the message display module 310 is replaced by a communication module 410. The communication module 410 is used to transmit predetermined message to at least one contact person. In this embodiment, the predetermined message corresponding to anger can be set as “XXX is very depressed today, he need to be comfort”, so that the contact person can comfort the user to lower emotional fluctuations of the user, when receiving the predetermined message.

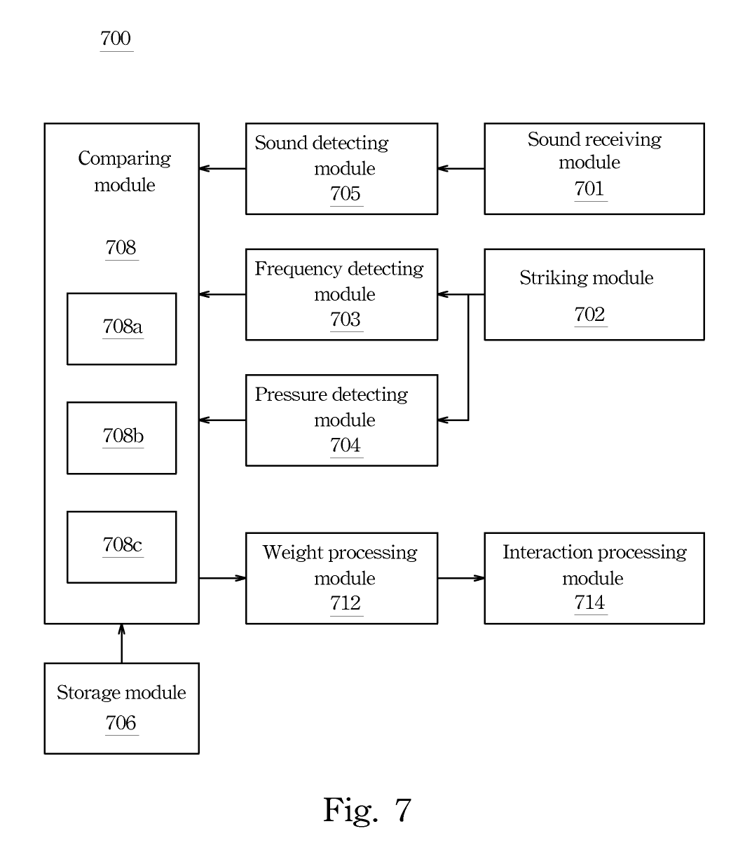

Refer to FIG. 5. FIG. 5 is a functional block diagram showing an information product 500 according to a fourth embodiment of the present invention. The information product 500 is similar to the information product 300, but the difference is in that the pressure detecting module 304 is replaced by a frequency detecting module 504, and the storage module 306 stores a plurality of predetermined frequency values, wherein the predetermined frequency values are collected samples when the user strikes the striking module 302 with various emotions. The frequency detecting module 504 is used to detect a striking frequency applied to the striking module 302 by the user, thereby outputting a user striking frequency to the comparing module 308. Then, the comparing module 308 determines if the user striking frequency substantially matches one of the predetermined frequency values, and outputs a comparing result. If the comparing result is yes, the comparing module 308 directs the message display module 310 to display the predetermine message corresponding to the user striking frequency value.

In addition, the message display module can be replaced by a communication module, and the communication module transmits a predetermined message to at least one contact person according to the comparing result.

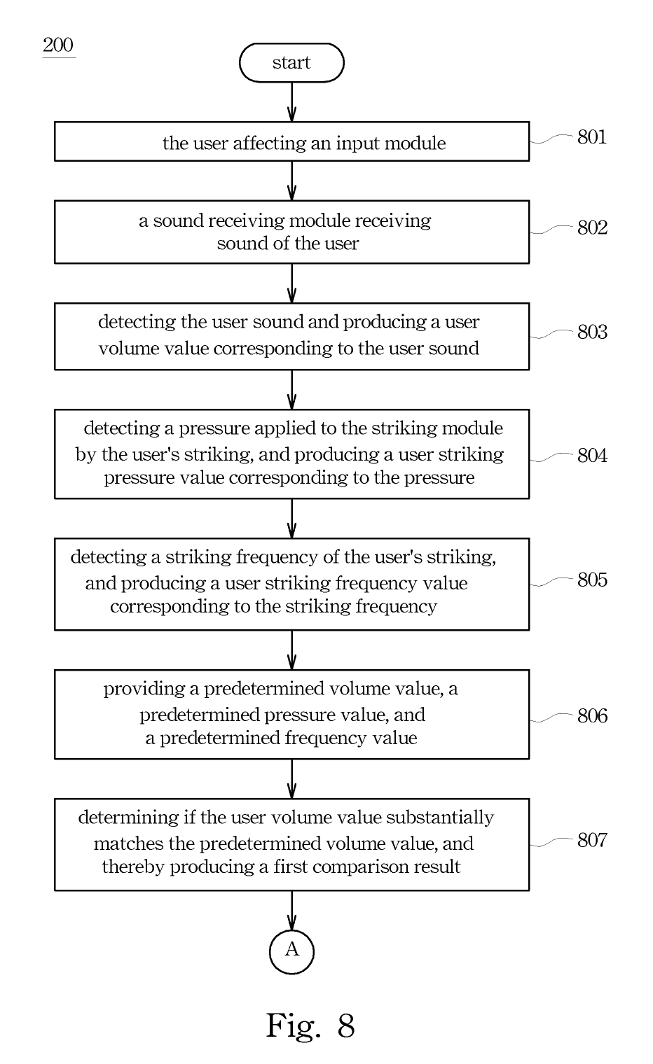

Refer to FIG. 6. FIG. 6 is a functional block diagram showing an information product 600 according to a fifth embodiment of the present invention. The information product 600 is an exemplary example for specifying the first embodiment. The information product 600 comprises a sound receiving module 602, a sound detect module 604, a storage module 606, a comparing module 608, and a message display module 610. The sound receiving module 602 is used to receive the user's sound. The sound-detecting module 604 is used to detect the user's sound, thereby outputting a user volume value. The storage module 606 stores a plurality of predetermined volume values, wherein the predetermined volume values are collected samples when the user speaks to sound receiving module 602 with various emotions. The comparing module 608 is used to determine if the user volume value substantially matches one of the predetermined volume values, thereby outputting a comparing result. When the comparing result is yes, the comparing module 608 directs the message display module to display a predetermined message, wherein the predetermined message corresponds to the user volume value.

In this example, the information product 600 is a mobile phone, and the sound receiving module 602 is a microphone module. At first, the user collects the predetermined volume values when he speaks to the microphone module in the state of anger, happiness, tension, and so on, wherein the predetermined volume values are samples corresponding to the user's various emotions in a one-to-one manner. Then, the storage module 606 is used to store the predetermined volume values. Thereafter, the message display module 610 is used to set each of the predetermined volume values to be corresponding to a predetermined message. For example, the predetermined message corresponding to anger can be “All things come to him who waits”. Then, the sound-detecting module 604 is used to detect the user sound when the user uses the mobile phone to communicate with other people, thereby outputting, thereby outputting a user volume value. Thereafter, the comparing module 608 is used to determine if the user volume value is equal to one of the predetermined volume values. When the user volume value is equal to the predetermined volume value corresponding to the emotion “anger”, the comparing module 608 directs the message display module 610 to display the words “All things come to him who waits”, thereby lowering the emotional fluctuations of the user. In addition, the message display module 610 may comprise a processor, a screen, and a horn, so the predetermined message can be set as words, images, or sounds.

In addition, the message display module can be replaced by a communication module, and the communication module transmits a predetermined message to at least one contact person according to the comparing result.

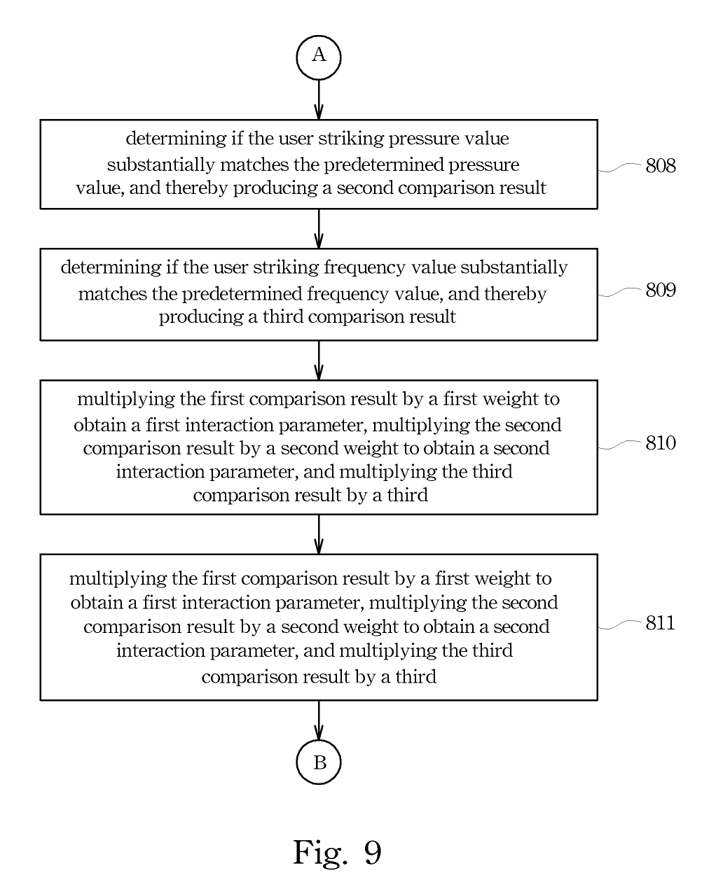

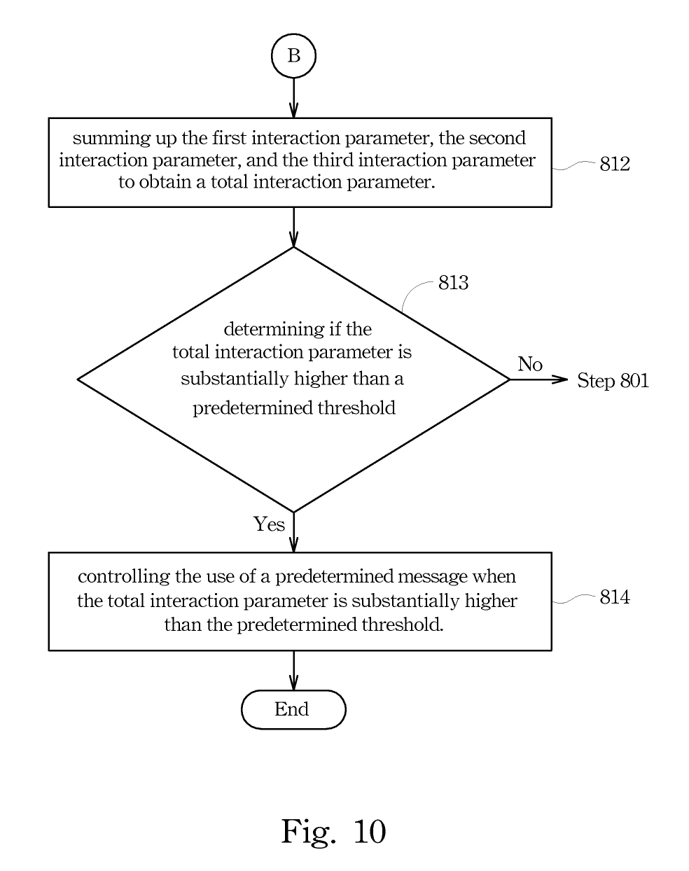

Refer to FIG. 7 to FIG. 10. FIG. 7 is a functional block diagram showing an information product 700 for interacting a user according to a seventh embodiment of the present invention. FIG. 8 to FIG. 10 is a flow chart showing a method 800 for interacting the user according to the seventh embodiment of the present invention. The information product 700 comprises: a sound receiving module 701, an striking module 702, a frequency detecting module 703, a pressure detecting module 704, a sound detecting module 705, a storage module 706, a comparing module 708, a weight processing module 712, and an interaction processing module 714, wherein the comparing module 708 comprises a sound comparing module 708a, a pressure comparing module 708b, and a frequency comparing module 708c.

In the method 800, the striking module 702 is firstly affected by the user in a step 801. Then, the sound receiving module 701 receives the user's sound in a step 802. Thereafter, the sound-detecting module 705 detects the user sound and produces a user volume value corresponding to the user sound in a step 803. Then, the pressure-detecting module 704 detects a pressure applied to the striking module by the user's striking, and produces a user striking pressure value corresponding to the pressure in a step 804. Thereafter, the frequency-detecting module 703 detects a striking frequency of the user's striking, and produces a user striking frequency value corresponding to the striking frequency in a step 805. Then, a predetermined volume value, a predetermined pressure value, and a predetermined frequency value are provided in a step 806. Thereafter, the comparing module 708 determines if the user volume value substantially matches the predetermined volume value, and thereby producing a first comparison result in a step 807. Then, the comparing module 708 determines if the user striking pressure value substantially matches the predetermined pressure value, and thereby producing a second comparison result in a step 808. Thereafter, the comparing module 708 determines if the user striking pressure value substantially matches the predetermined frequency value, and thereby producing a third comparison result in a step 809. Then, the weight processing module multiplies the first comparison result by a first weight to obtain a first interaction parameter, multiplies the second comparison result by a second weight to obtain a second interaction parameter, and multiplies the third comparison result by a third weight to obtain a third interaction parameter in a step 811. Thereafter, the interaction processing module 714 sums up the first interaction parameter, the second interaction parameter, and the third interaction parameter to obtain a total interaction parameter in a step 812. Then, the interaction processing module 714 determines if the total interaction parameter is substantially higher than a predetermined threshold in a step 813. When the total interaction parameter is substantially higher than the predetermined threshold, the use of a predetermined message is controlled in a step 814. For specifying the seventh embodiment, various exemplary examples are presented in the following description.

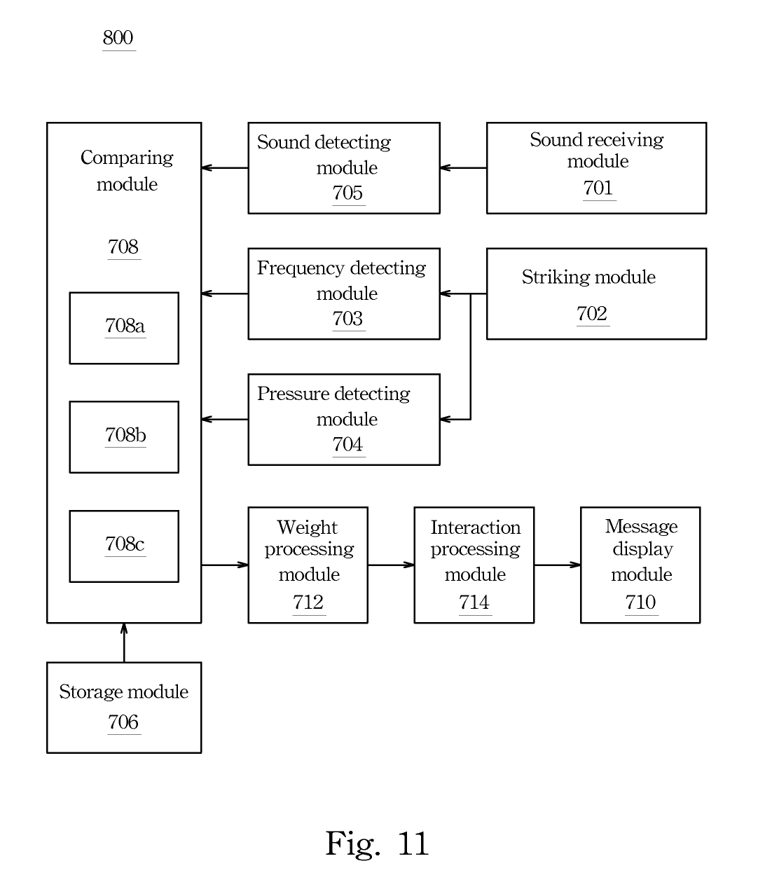

Refer to FIG. 11. FIG. 11 is a functional block diagram showing an information product 800 according to an eighth embodiment of the present invention. The information product 800 comprises: the sound receiving module 701, the striking module 702, the frequency detecting module 703, the pressure detecting module 704, the sound detecting module 705, the storage module 706, the comparing module 708, a message display module 710, the weight processing module 712, and the interaction processing module 714.

In this embodiment, the sound receiving module 701 is used to receive the user sound, and the striking module 702 is for being struck by the user to control the information product 800. The sound detecting module 705 is used to detect the volume of the user sound, thereby outputting a user volume value. The pressure detecting module 704 is used to detect a pressure applied to the striking module by the user, thereby outputting a user striking pressure value. The frequency detecting module 703 is used to detect a striking frequency applied to the striking module by the user, thereby outputting a user striking frequency value. The storage module 706 stores a predetermined volume value, a predetermined pressure value, and a predetermined striking frequency value. In the comparing module 708, the sound comparing module 708a is used to determine if the user volume value substantially matches the predetermined volume value, thereby providing a first comparing result. The pressure comparing module 708b is used to determine if the user striking pressure value substantially matches the predetermined pressure value, thereby outputting a second comparing result. The frequency comparing module 708c is used to determine if the user striking frequency value substantially matches the predetermined frequency value, thereby outputting a third comparing result. The weight processing module 712 is used to multiply the first comparing result by a first weight to obtain a first interaction parameter, and multiply the second comparing result by a second weight to obtain a second interaction parameter, and multiply the third comparing result by a third weight to obtain a third interaction parameter. The interaction processing module 714 is used to sum up the first interaction parameter, the second interaction parameter, and third interaction parameter to obtain a total interaction parameter, and determine if the total interaction parameter is bigger than a predetermined threshold. When the total interaction parameter is bigger than a predetermined threshold, the interaction processing module 414 directs the message display module 710 to display the predetermined message. The followings are exemplary example for specifying the fourth embodiment.

In this example, the information product 800 is a mobile phone, wherein the mobile phone comprises a keyboard and a microphone module. At first, the user collects a predetermined pressure value, a predetermined volume value, and a predetermined striking frequency value, when he strikes the keyboard and speaks to the microphone in an emotion, such as anger, happiness, tension, and so on. Then, the storage module 706 is used to store the predetermined striking frequency value, the predetermined volume value, and the predetermined pressure value. Thereafter, the message display module 710 is used to set a predetermined message corresponding to the emotion, for example: anger, as “All things come to him who waits”. Then, the volume detecting module 705, the pressure detecting module 704, and the frequency detecting module 706 are use to detect the user volume value, the user striking pressure value, and the user striking frequency value respectively. Thereafter, the comparing module 708 is used to determine if the user volume value is equal to the predetermined volume value, thereby outputting a first comparing result; determine if the user striking pressure value is equal to the predetermined pressure value, thereby outputting a second comparing result; and determine if the user striking frequency value is equal to the predetermined frequency value, thereby outputting a third comparing result. Then, the weight processing module 712 is used to multiply the first result by a first weight to obtain a first interaction parameter; multiply the second result by a second weight to obtain a second interaction parameter; and multiply the third result by a third weight to obtain a third interaction parameter. It is noted that when the value of the comparing result is “1”, the comparing result is yes, and when the value of the comparing result is “0”, the comparing result is No. Then, the interaction processing module 714 is used to sum up the first interaction parameter, the second interaction parameter, and the third interaction parameter to obtain a total interaction parameter, and determine if the total interaction parameter is bigger than a predetermined threshold. When the total interaction parameter is bigger than the predetermined threshold, the user may be in anger, therefore the interaction processing module 714 directs the message display module 710 to display the predetermined message “All things come to him who waits” to lower the emotional fluctuations of the user.

In addition, the message display module can be replaced by a communication module, and the communication module transmits a predetermined message to at least one contact person according to the comparing result.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. An information product for interacting with a user, the information product comprising:
an input module for being affected by the user to control the information product;
a storage module for storing a predetermined input value, wherein the predetermined input value corresponds to a predetermined message;
a detecting module for producing a user input value corresponding to the user's affecting the input module; and
a comparing module for determining if the user input value substantially matches the predetermined input value;
wherein when the user input value substantially matches the predetermined input value, the comparing module controls the use of the predetermined message.

2. The information product of claim 1, wherein the information product further comprises a message display module, the input module is struck by the user to control the information product, and for producing the user input value the detecting module is used to detect a pressure applied to the input module by the user's striking; and
when the user input value substantially matches the predetermined input value, the comparing module directs the message display module to display the predetermined message.

3. The information product of claim 1, wherein the information product further comprises a message display module, the input module is struck by the user to control the information product, and for producing the user input value the detecting module is used to detect a striking frequency of the user's striking; and
when the user input value substantially matches the predetermined input value, the comparing module directs the message display module to display the predetermined message.

4. The information product of claim 1, wherein the information product further comprises a communication module, the input module is struck by the user to control the information product, and for producing the user input value the detecting module is used to detect a pressure applied to the input module by the user's striking; and
when the user input value substantially matches the predetermined input value, the comparing module directs the communication module to transmit the predetermined message to at least one predetermined contact person.

5. The information product of claim 1, wherein the information product further comprises a communication module, the input module is struck by the user to control the information product, and for producing the user input value the detecting module is used to detect a striking frequency of the user's striking; and
when the user input value substantially matches the predetermined input value, the comparing module directs the communication module to transmit the predetermined message to at least one predetermined contact person.

6. The information product of claim 1, wherein the information product further comprises a message display module, the input module receives sound of the user, and for producing the user input value the detecting module is used to detect the user sound; and
when the user input value substantially matches the predetermined input value, the comparing module directs the message display module to display the predetermined message.

7. The information product of claim 1, wherein the information product further comprises a communication module, the input module receives sound of the user, and for producing the user input value the detecting module is used to detect the user sound; and
when the user input value substantially matches the predetermined input value, the comparing module directs the communication module to transmit the predetermined message to at least one predetermined contact person.

8. The information product of claim 1, wherein the predetermined message is composed of symbols selected from a group consisting of sounds, images, and words.

9. An information product for interacting with a user, the information product comprising:
a striking module for being struck by the user to control the information product;
a sound receiving module for receiving sound of the user;
a sound detecting module for detecting the user sound and producing a user volume value corresponding to the user sound;
a pressure detecting module for detecting a pressure applied to the striking module by the user's striking, and producing a user striking pressure value corresponding to the pressure;
a frequency detecting module for detecting a striking frequency of the user's striking, and producing a user striking frequency value corresponding to the striking frequency;
a storage module for storing a predetermined volume value, a predetermined pressure value, and a predetermined frequency value;
a sound comparing module for determining if the user volume value substantially matches the predetermined volume value, and thereby producing a first comparison result;
a pressure comparing module for determining if the user striking pressure value substantially matches the predetermined pressure value, and thereby producing a second comparison result;
a frequency comparing module for determining if the user striking frequency value substantially matches the predetermined frequency value, and thereby producing a third comparison result;
a weight processing module for multiplying the first comparison result by a first weight to obtain a first interaction parameter, multiplying the second comparison result by a second weight to obtain a second interaction parameter, and multiplying the third comparison result by a third weight to obtain a third interaction parameter; and
an interaction processing module for summing up the first interaction parameter, the second interaction parameter, and the third interaction parameter to obtain a total interaction parameter, and determining if the total interaction parameter is substantially higher than a predetermined threshold;
wherein when the total interaction parameter is substantially higher than the predetermined threshold, the interaction processing module controls the use of a predetermined message.

10. The information product of claim 9, wherein the information product further comprises a message display module, and when the total interaction parameter is substantially higher than the predetermined threshold, the interaction processing module directs the message display module to display the predetermined message.

11. The information product of claim 9, wherein the information product further comprises a communication module, and when the total interaction parameter is substantially higher than the predetermined threshold, the interaction processing module directs the communication module to transmit the predetermined message to at least one predetermined contact person.

12. The information product of claim 9, wherein the predetermined message is composed of symbols selected from a group consisting of sounds, images, and words.

13. A method for interacting with a user, the method comprising:
the user affecting an input module;
providing a predetermined input value, wherein the predetermined input value corresponds to a predetermined message;
producing a user input value corresponding to the user's affecting the input module;
determining if the user input value substantially matches the predetermined input value; and
controlling the use of the predetermined message when the user input value substantially matches the predetermined input value.

14. The method of claim 13, wherein the step of the user affecting the input module comprises striking the input module, the user input value is produced by detecting a pressure applied to the input module by the user's striking, and the step of controlling the use of the predetermined message comprises displaying the predetermined message.

15. The method of claim 13, wherein the step of the user affecting the input module comprises striking the input module, the user input value is produced by detecting a striking frequency of the user's striking, and the step of controlling the use of the predetermined message comprises displaying the predetermined message.

16. The method of claim 13, wherein the step of the user affecting the input module comprises striking the input module, the user input value is produced by detecting a pressure applied to the input module by the user's striking, and the step of controlling the use of the predetermined message comprises transmitting the predetermined message to at least one predetermined contact person.

17. The method of claim 13, wherein the step of the user affecting the input module comprises striking the input module, the user input value is produced by detecting a striking frequency of the user's striking, and the step of controlling the use of the predetermined message comprises transmitting the predetermined message to at least one predetermined contact person.

18. The method of claim 13, wherein the input module is affected by the user by receiving sound of the user, the user input value is produced by detecting the user sound, and the step of controlling the use of the predetermined message comprises displaying the predetermined message.

19. The method of claim 13, wherein the input module is affected by the user by receiving sound of the user, the user input value is produced by detecting the user sound, and the step of controlling the use of the predetermined message comprises transmitting the predetermined message to at least one predetermined contact person.

20. The method of claim 13, wherein the predetermined message is composed of symbols selected from a group consisting of sounds, images, and words.

21. A method for interacting with a user, the method comprising:
the user striking a striking module;
a sound receiving module receiving sound of the user;
detecting the user sound and producing a user volume value corresponding to the user sound;
detecting a pressure applied to the striking module by the user's striking, and producing a user striking pressure value corresponding to the pressure;
detecting a striking frequency of the user's striking, and producing a user striking frequency value corresponding to the striking frequency;
providing a predetermined volume value, a predetermined pressure value, and a predetermined frequency value;
determining if the user volume value substantially matches the predetermined volume value, and thereby producing a first comparison result;
determining if the user striking pressure value substantially matches the predetermined pressure value, and thereby producing a second comparison result;
determining if the user striking frequency value substantially matches the predetermined frequency value, and thereby producing a third comparison result;
multiplying the first comparison result by a first weight to obtain a first interaction parameter, multiplying the second comparison result by a second weight to obtain a second interaction parameter, and multiplying the third comparison result by a third weight to obtain a third interaction parameter;
summing up the first interaction parameter, the second interaction parameter, and the third interaction parameter to obtain a total interaction parameter, and determining if the total interaction parameter is substantially higher than a predetermined threshold; and
controlling the use of a predetermined message when the total interaction parameter is substantially higher than the predetermined threshold.

22. The method of claim 21, wherein the step of controlling the use of the predetermined message comprises displaying the predetermined message.

23. The method of claim 21, wherein the step of controlling the use of the predetermined message comprises transmitting the predetermined message to at least one predetermined contact person.

24. The method of claim 21, wherein the predetermined message is composed of symbols selected from a group consisting of sounds, images, and words.
